(19) United States
(12) Patent Application Publication
(10) Pub. No.: US 2005/0060869 A1
(43) Pub. Date: Mar. 24, 2005

(54) Method for the production of a side wall module for the bodywork of a motor vehicle

(76) Inventors: Martin Brodt, Renningen (DE); Klaus Kleinhans, Bondorf (DE); Peter Mack, Gaeufelden (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/492,843

(22) PCT Filed: Sep. 4, 2002
(86) PCT No.: PCT/EP02/09890

(30) Foreign Application Priority Data
Oct. 19, 2001 (DE) 101 51685.1

(51) Int. Cl. B23P 17/04

(52) U.S. Cl. 29/592

(57) ABSTRACT

The invention relates to a method for the production of a side wall module for the bodywork of a motor vehicle, having a panel which leaves open a side wall part. In this case, a side wall structure, which extends to the rear in the longitudinal direction of the vehicle at least from an A-pillar as far as a rear wheel mounting and comprises an inner part and a wall part integrally reinforcing the side wall module, is joined in the transverse direction of the vehicle to a side wall panel which has previously been deep drawn from a blank and cut, with window openings and at least one door opening being formed. The wall part is fastened on the outside of the inner part of the side wall structure. In order to make it possible for a side wall module with a panel leaving open a side wall part to be produced reliably, it is proposed that the blank is cut in such a manner that at least one stiffening sheet-metal section which partially covers the opening remains in the window openings and/or the door openings of the panel, that after a process of clamping the panel the latter is joined to the side wall structure, and that, finally, the respective stiffening sheet-metal section is severed.

### BACKGROUND AND SUMMARY OF THE INVENTION

This invention relates to a method for the production of a side wall module for the bodywork of a motor vehicle.

A method of this general type is described in German document DE 195 31 874 C1. This document describes a side wall module for use in sedans. The module is composed of a panel part and a multi-part side wall structure. The side wall structure is basically formed by an inner part and a wall part which is fastened on the outside of the inner part and integrally reinforces the side wall module. The inner part comprises, as separate components, the C-pillar, the rear wheel mounting with a sill section extending forward, and a lateral roof framed section, and also the front door cutout with an A-pillar, a front wall pillar, a B-pillar, the rest of the lateral roof frame, and the rest of the sill. The reinforcing part is essentially adapted in terms of shape from the front door cutout, the reinforcing part additionally extending over the entire sill region. In order to satisfy requirements in terms of lightweight construction, the sill and also the B-pillar (according to FIG. 2b) are designed to be free of panels, in a manner saving on material, and their surfaces themselves constitute the outwardly optically visible outer skin of the bodywork in this region. Owing to the function of the optically visible outer skin being taken on by the inner part and the reinforcing part, the outer panel is designed such that it projects less with respect to the sill and B-pillar than usual, since the sill and B-pillar remain left open, so that the entire side wall module is reduced by a relatively large amount of weight. The panel is joined to the inner part together with the reinforcing part, which is fastened to the latter, transversely with respect to the longitudinal direction of the module.

However, the production of the side wall module is problematical in that panels which are left open in such a manner become distorted to such an extent, due to a lack of sufficient inherent stability, on the one hand, and the metal sheet springing up, on the other hand, after removal from the pressing tool, that it is virtually impossible to join the panel to the reinforced inner part.

The invention has as one object the object of developing a method by which a side wall module having a panel which leaves open a side wall part can be produced reliably in a simple manner.

This object is achieved according to the invention by the features claimed.

Owing to a stiffening sheet-metal section remaining in the door and/or window opening after a first preliminary cutting of the deep-drawn blank in the pressing unit, the structural geometry of the panel is retained in a simple manner after the panel is removed from the pressing tool, with the result that the panel can be transported without any problems to the manufacturing of the body shell. An additional and expensive outlay on clamping, which is associated with risks in respect of assembly tolerances and reliability, may be omitted, since the panel in this state still has sufficient inherent stiffness, with the result that it can be clamped and joined in a conventional manner in the joining device for assembly together with the structure. After the joining process, the sheet-metal section can be separated from the respective opening frame in a relatively simple manner in a second final cutting process, so that the panel in the joined state corresponds to the desired shape. The solution according to the invention makes it possible to obtain in a simple manner the largest possible cutouts on the panel with therefore a very high reduction in the weight of the panel and the side wall module without putting the reliability of the production of the module at risk.

Expedient refinements of the invention can be gathered from the subclaims; moreover, the invention is explained in greater detail below with reference to a number of exemplary embodiments which are illustrated in the drawings.

### BRIEF DESCRIPTION OF THE DRAWINGS

FIG. 1 shows, in a side view, a panel which has been removed from a pressing tool and belongs to a side wall module, which is produced according to the invention, having a sheet-metal section which completely stiffens the driver's door opening,

FIG. 2 shows, in a lateral longitudinal section along the line II-II of FIG. 1, the joined panel during the severing of a sheet-metal section, and

FIG. 3 shows, in a side view, a panel which has been removed from a pressing tool and belongs to a side wall module, which is produced according to the invention, having a sheet-metal section which stiffens the driver's door opening and a rear door opening in the sill region.

### DETAILED DESCRIPTION OF THE INVENTION

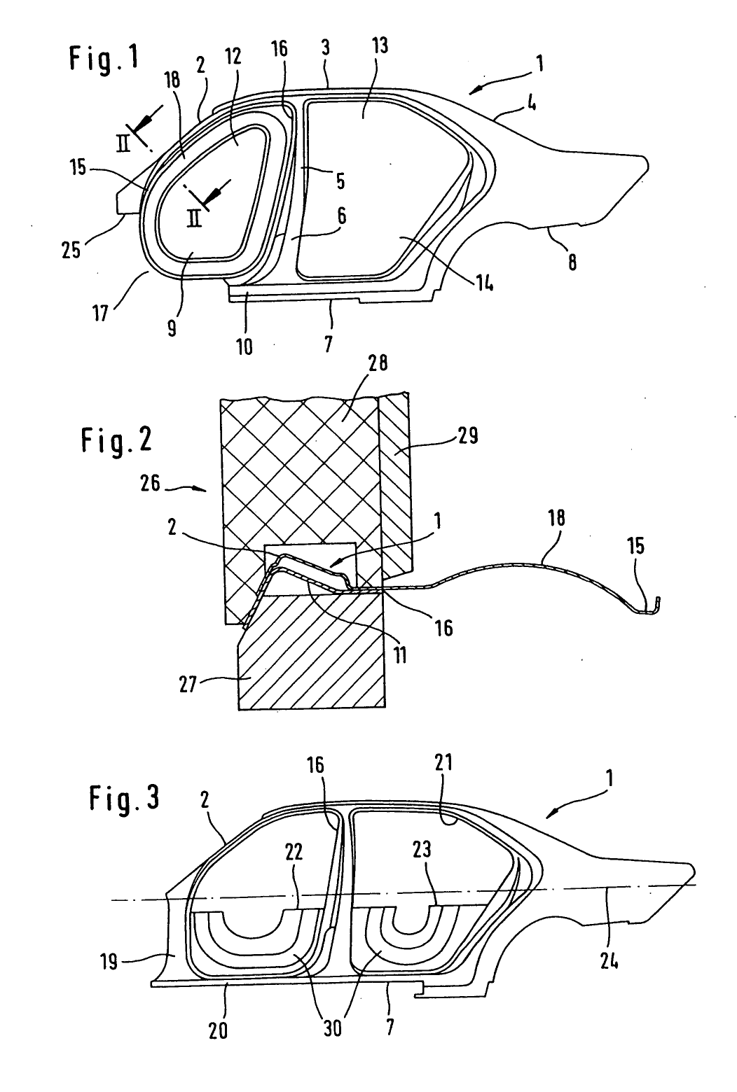

FIG. 1 illustrates a panel 1 of a side wall module for the bodywork of a motor vehicle, the panel 1 being a single-component sheet-metal pressed part which extends to the rear in the longitudinal direction of the vehicle from an A-pillar 2, which starts at the wind shield, over a lateral roof frame 3 and, firstly, over a C-pillar 4 and, secondly, over a B-pillar 5, a box-section pillar 6 and a sill section 7 to a rear wheel mounting 8. The front wall pillar 19, which would adjoin the A-pillar 2 toward the bottom, is, in the case of the panel 1, left open in exactly the same manner as the sill region 20 situated below the driver's door opening 9. In the exemplary embodiment, only one extension 10 of the sill section 7, which extension reaches into this sill region 20, is formed. The abovementioned sill region 20 and the front wall pillar 19 are formed by a side wall structure, which also takes on there the optically outwardly effective part of the panel 1. The structure is produced from an inner part 11 (FIG. 2) and a wall part, which integrally reinforces the side wall module, which parts are joined, preferably welded or bonded, to each other. In this case, the wall part is fastened on the outside of the inner part 11 of the side wall structure.

The panel 1 which leaves open a side wall part—in this case, the front wall pillar 19 and the sill region 20 adjoining it are left open—is deep drawn from a blank and is cut in the pressing tool, with window openings 12 and 13 and door openings 9 and 14 on the driver's side and rear side being formed. In this case, however, a sheet-metal section 15 is left in place, said section partially covering the openings 12 and 9 and running annularly along the entire opening frame 16. This sheet-metal section 15, which is perpendicular to the center of the openings 9 and 12, acts in a stiffening manner on the opening frame 16 and the panel parts connected thereto, such as the A-pillar 2, the lateral roof frame 3 and the B-pillar 5, in such a manner that the panel 1 obtains an inherent stability and is not subject to any distortions when the panel 1 is removed from the pressing tool. Owing to the annular nature of the sheet-metal section 15, the cutout 17 is spanned, which results in a solid and therefore relatively flexurally rigid subsection of the panel 1. The sheet-metal section 15 will project to a greater or lesser extent into the openings 9 and 12 depending in each case on the stiffening strength required as a function of the location of the cutout and the thickness of the frame 16. For example, the sheet-metal section 15 is configured to be particularly wide at the location of the cutout and where the frame 16 is of particularly thin design. In order to increase the stiffening action of the sheet-metal section 15, a stiffening bead 18 which runs along the entire opening frame 16 is formed on the edge of the section 15 at the same time as the blank is being pressed. As a result, the width of the sheet-metal section 15 can be reduced while the stiffening action is at least just as high, so that, during the later transportation of the panel part 1, the additional outlay on carrying as a consequence of the small additional weight is insignificant. Instead of the annular design of the stiffening bead 18, the local arrangement of a plurality of individual beads is also conceivable. Furthermore, the described stiffening does not exclusively concern the window and door opening 9 and 12 of the driver's side, but may also be formed in just the same manner in the window and door opening 13 and 14 of the rear.

One variant of the described panel 1 can be seen in FIG. 3. Here the sheet-metal section remains only where the opening frame has a material weakening. Although, in the variant, the front wall pillar 19 is formed on the A-pillar 2 and the front sill region 20 can likewise be seen, the latter, like the sill section 7 too, is configured to be very narrow, for weight-saving reasons, so that despite the closed frame 16 there are stiffness labilities in the sill region 20 and in the section 7. In this case, the cutout relates to the only partial formation of the sill in respect of the width. In order to compensate for these labilities, sheet-metal sections 22 and 23 are formed within the frames 16 and 21 directly above the sill region 20 and the sill section 7 during the pressing and cutting of the panel 1, but they extend merely from the sill regions 20 and 7 to just below the belt line 24 of the panel 1, since the remaining frame sections do not require any stiffening. In order to increase the stiffness, semicircular reinforcing beads 30 which run along the frames 16 and 21 are formed in the sheet-metal sections 22 and 23. The variant has the advantage that, owing to the closed frames 16 and 21, in particular in the region of the front wall pillar 19, no complicated finishing operations for the end edge 25 of the A-pillar 2 of the preceding variant are required.

The panel 1 is now fixed in a clamping device 26 and then joined in the transverse direction of the vehicle to the side wall structure. The clamping device 26 shown in FIG. 2 comprises a mount 27 and a holding-down device 28. In this case, the adjoining parts are clamped in such a manner that the sheet-metal sections 15 or 22 and 23 are entirely freely accessible. Finally, after a process of clamping the panel 1, the respective stiffening sheet-metal section 15 or 22, 23 is severed from the frames 16 and/or 21 of the completely joined side wall module while the panel 1 is clamped in place. This takes place in a simple manner by means of a punching device, which is represented by here by a cutting punch 29 and a cutting die, the latter being formed by the clamping mount 27. It is similarly conceivable to sever the sheet-metal sections 15 or 22, 23 by means of laser cutting. Although, on the one hand, this requires a very high investment and gives rise to longer process cycle times during production, on the other hand, the laser cutting device is not dependent on the shape of the panel 1, the shape usually differing from vehicle type to vehicle type, so that the provision repeatedly of new type-dependent cutting tools requiring an outlay on production and place to locate them can be saved.

1-5. (canceled)

6. A method for producing a side wall module for bodywork of a motor vehicle, having a panel which leaves open a side wall part, the side wall structure, which extends to the rear in the longitudinal direction of the vehicle at least from an A-pillar as far as a rear wheel mounting and comprises an inner part and a wall part integrally reinforcing the side wall module, being joined in the transverse direction of the vehicle to a side wall panel which has previously been deep drawn from a blank and cut, with window openings and at least one door opening being formed, the wall part being fastened on the outside of the inner part of the side wall structure, comprising:
cutting the blank in such a manner that at least one stiffening sheet-metal section which at least partially covers the opening remains in the window openings, the at least one door opening, or both the window openings and the at least one door opening,
joining the panel to the side wall structure after a process of clamping the panel, and
serving a respective stiffening sheet-metal section.

7. The method as claimed in claim 6, wherein the at least one sheet-metal section remains along with an entire opening frame.

8. The method as claimed in claim 6, wherein the at least one sheet-metal section remains only where the opening frame has a material weakening.

9. The method as claimed in claim 6, wherein at least one stiffening bead which runs along the opening frame is formed in the at least one sheet-metal section during pressing of the blank.

10. The method as claimed in claim 6, wherein the at least one sheet-metal section is punched out while the completely adjoined side wall module is clamped in place.

11. The method as claimed in claim 7, wherein at least one stiffening bead which runs along the opening frame is formed in the at least one sheet-metal section during pressing of the blank.

12. The method as claimed in claim 8, wherein at least one stiffening bead which runs along the opening frame is formed in the at least one sheet-metal section during pressing of the blank.

13. The method as claimed in claim 7, wherein the at least one sheet-metal section is punched out while the completely adjoined side wall module is clamped in place.

14. The method as claimed in claim 8, wherein the at least one sheet-metal section is punched out while the completely adjoined side wall module is clamped in place.

15. The method as claimed in claim 9, wherein the at least one sheet-metal section is punched out while the completely adjoined side wall module is clamped in place.

16. The method as claimed in claim 11, wherein the at least one sheet-metal section is punched out while the completely adjoined side wall module is clamped in place.

17. The method as claimed in claim 12, wherein the at least one sheet-metal section is punched out while the completely adjoined side wall module is clamped in place.
